(19) United States
(12) Patent Application Publication
(10) Pub. No.: US 2016/0343061 A1
(43) Pub. Date: Nov. 24, 2016

(54) SHOPPING SUPPORTING APPARATUS AND SHOPPING SUPPORTING METHOD

(71) Applicant: CASIO COMPUTER CO., LTD., Tokyo (JP)

(72) Inventors: Hideo SUZUKI, Tokyo (JP); Kiyoshi OGISHIMA, Tokyo (JP); Hiroshi AKAO, Tokyo (JP)

(73) Assignee: CASIO COMPUTER CO., LTD., Tokyo (JP)

(21) Appl. No.: 15/074,419

(22) Filed: Mar. 18, 2016

(30) Foreign Application Priority Data
May 22, 2015 (JP) 2015-104451

(51) Int. Cl. G06Q 30/06

(52) U.S. Cl. CPC G06Q 30/0633

(57) ABSTRACT

A shopping supporting apparatus is provided. The apparatus has a receiving unit for receiving an electronic receipt which receipt clearly indicates a payment amount of the purchased goods and store information of the store at which a user has purchased the goods, a receipt memorizing unit for memorizing plural electronic receipts as history information of the electronic receipts, a list memorizing unit for memorizing a commodity list created by the user at his/her arbitrary option, an extracting unit for referring to the history information, thereby extracting a candidate good to be purchased at present or at a present position from among the plural goods included in the commodity list, and a displaying unit for displaying the extracted candidate good.

### CROSS-REFERENCE TO RELATED APPLICATION

The present application is based upon and claims the benefit of priority from the prior Japanese Patent Application No. 2015-104451, filed May 22, 2015, the entire contents of which are incorporated herein by reference.

### BACKGROUND OF THE INVENTION

1. Field of the Invention

The present invention relates to a shopping supporting apparatus and a shopping supporting method.

2. Description of the Related Art

In recent, an electronic receipt system is proposed, in which POS (Point Of Sales) terminal converts information of a receipt into electronic data, and a user uses his/her mobile terminal and/or personal computer to obtain the electronic data of the receipt, whereby the electronic data of the receipt can be exchanged between the POS terminal and the mobile terminal and/or personal computer. One example of the electronic receipt system is such that POS terminal obtains the identification information of a customer and associates the customer's identification information with information of the electronic receipt generated by the POS terminal, and further the POS terminal stores the associated data in a database of a server connected thereto through a network. The customer of the mobile terminal or personal computer uses his/her identification information to access to the database of the server, thereby downloading information of his/her desired electronic receipt.

Using the electronic receipts, the customer can keep his/her household account book automatically and electronically, and the customer is not required to receive unwanted paper receipts. Therefore, the electronic receipt system is very convenient for the customers. Meanwhile, the employment of electronic receipts can reduce consumption of paper receipts and can simplify operation of handing the paper receipts to customers. Therefore, the electronic receipts are very convenient for the stores employing the electronic receipt system. It is expected that the advantages of the electronic receipt system will promote employment of the same system in future.

In the meantime, sometimes the customer prepares and keeps a memo for shopping goods at a store to prevent from forgetting purchasing the goods. But to make such shopping memo or a shopping list by hand-writing will be troublesome for the customer. A solution to such a troublesome working is proposed, that is, electronic receipts are referred to prepare the shopping list, requiring no troublesome work of making the hand-written shopping list.

Japanese Unexamined Patent Publication No. 2009-59173 discloses a technique, in which an electronic receipt issued by a store is referred to a prepared shopping list to extract goods which are written in the shopping list but are not indicated in the electronic receipt, thereby giving warning that the extracted goods have not yet been purchased.

In the technique disclosed by Japanese Unexamined Patent Publication No. 2009-59173, the customer is required to do troublesome hand-writing operation to prepare the shopping memo, and it is expected to simplify the hand-writing operation to prepare the shopping memo. The shopping supporting apparatus and the shopping supporting method of the present invention can extract candidate goods to be purchased from the electronic receipts issued in the past to prepare a shopping list in a simple manner.

### SUMMARY OF THE INVENTION

According to one aspect of the invention, there is provided a shopping supporting apparatus of a portable type, which comprises a receiving unit which receives an electronic receipt when a user of the apparatus has purchased goods at a store, which receipt clearly indicates a payment amount of the purchased goods and store information of the store at which the user has purchased the goods, a receipt memorizing unit which memorizes plural electronic receipts received by the receiving unit as history information of the electronic receipts, a list memorizing unit which allows the user to create and memorize a list of plural goods to be remarked, wherein the list of plural goods is a commodity list created by the user at his/her arbitrary option, an extracting unit which refers to the history information of the electronic receipts to extract a candidate good to be purchased at present or at a present position from among plural goods included in the commodity list, and a displaying unit which displays the candidate good extracted by the extracting unit.

The shopping supporting apparatus according to the invention can extract candidate goods to be purchased from purchase history indicated in electronic receipts issued in the past.

### BRIEF DESCRIPTION OF THE DRAWINGS

FIG. 1 is a view schematically showing a configuration of an electronic receipt system according to the first embodiment of the invention.

FIG. 2 is a view showing a configuration of a smart phone used in the electronic receipt system according to the first embodiment of the invention.

FIG. 3 is a view showing a sequence of processes for issuing an electronic receipt.

FIG. 4 is a view showing a logical composition of the electronic receipt system according to the first embodiment of the invention.

FIG. 5A is a view showing the electronic receipt database stored in a server of the electronic receipt system according to the first embodiment of the invention.

FIG. 5B is a view showing the store database stored in the server of the electronic receipt system according to the first embodiment of the invention.

FIG. 6A is a view showing the list of goods to be remarked (remarked good list) stored in the smart phone.

FIG. 6B is a view showing purchase history data stored in the smart phone.

FIG. 7 is a view showing a configuration of analysis data stored in the smart phone.

FIG. 8A is a view showing an initial screen of a shopping supporting program.

FIG. 8B is a view showing a screen for setting the remarked good list (remarked-good list setting screen).

FIG. 9A is a view showing a purchase-trend analyzing screen.

FIG. 9B is a view showing an advice setting screen.

FIG. 10A is a view showing the shopping-candidate list screen.

FIG. 10B is a view showing the receipt selecting screen.

FIG. 11A is a view showing the shopping list input screen.

FIG. 11B is a view showing a screen indicating store-conditions in a popup (store-condition popup).

FIG. 12A is a view showing a shopping list screen.

FIG. 12B is a view showing another store-condition popup.

FIG. 13A is a view showing the shopping list screen.

FIG. 13B is a view showing a time-condition popup.

FIG. 14A is a view showing a time-condition popup.

FIG. 14B is a view showing an advice screen giving advice on prices.

FIG. 15 is a view showing a purchase comparison screen.

FIG. 16 is a view showing a mode transition of the shopping supporting program.

FIG. 17 is a view showing a mode transition, when the shopping supporting program permanently resides.

FIG. 18 is a view schematically showing a configuration of the electronic receipt system according to the second embodiment of the invention.

FIG. 19 is a view showing the logical composition of the electronic receipt system according to the second embodiment of the invention.

### DETAILED DESCRIPTION OF THE PREFERRED EMBODIMENTS

Now, the embodiments of the present invention will be described with reference to the accompanying drawings in detail.

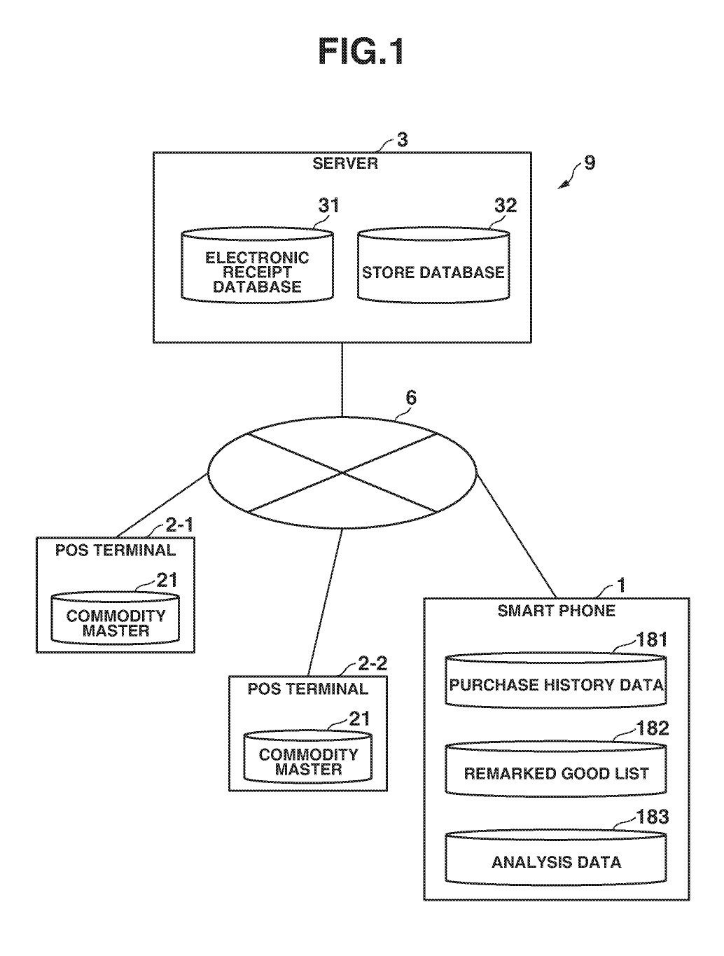

FIG. 1 is a view schematically showing a configuration of an electronic receipt system 9 according to the first embodiment of the invention.

Settlement terminals, that is, POS (Point Of Sales) terminals 2-1, 2-2 are installed in respective stores, and each of the POS terminals 2-1, 2-2 stores a commodity master 21 therein. The POS terminals 2-1, 2-2 are connected to a server 3 through a network 6. The POS terminals 2-1, 2-2 are not restricted to 2 units, but any number of POS terminals can be used in the system. Further, it is possible to store the commodity master 21 in the server, which the POS terminals 2-1, 2-2 are allowed to refer to. Hereinafter, when it is not required to especially discriminate the POS terminals 2-1, 2-2 from each other, the POS terminals 2-1, 2-2 will be simply referred to as the “POS terminal 2”. The POS terminal 2 has a function of converting information of a receipt representing contents of a settled commerce into electronic data to create an electronic receipt.

A public communication network, that is, the network 6 is connected with the POS terminals 2-1, 2-2, the server 3 and a smart phone 1.

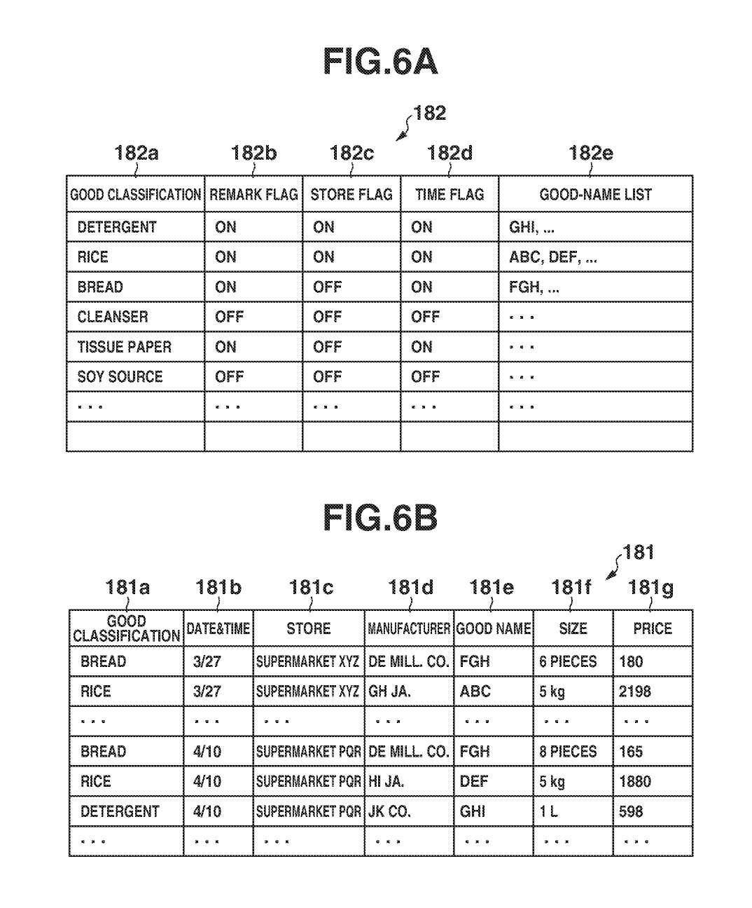

The server 3 stores an electronic receipt database 31 for memorizing electronic receipts generated by the POS terminal 2. Further, the server 3 stores the electronic receipt generated by the POS terminal 2 in the electronic receipt database 31 and sends the electronic receipt to the smart phone 1 through the network 6. The server 3 stores in a store database 32 information of the stores which is installed with the POS terminal 2. The electronic receipt database 31 will be described with reference to FIG. 6A in detail later. Also, the store database 32 will be described with reference to FIG. 6B in detail later.

The smart phone 1 stores purchase history data 181, a list of goods to be remarked (remarked good list) 182, and analysis data 183. The smart phone 1 makes the POS terminal 2 recognize its own identification information at settlement of a commercial trade. Meanwhile, the POS terminal 2 associates the electronic receipt concerning the commercial trade with the identification information and stores them in server 3. The smart phone 1 is, for example, a mobile terminal which can be connected with the network 6, and has a function of accessing to the server 3 to selectively download from the server 3 the electronic receipt identified by the identification information.

The smart phone 1 is capable of creating, recording, and browsing the remarked good list 182, that is, a list of goods which are worthy of remark. Further, the smart phone 1 downloads an electronic receipt from the server 3 through the network 6 to check the content of the electronic receipt, that is, information of the receipt represented by electronic data (electronic receipt), by comparing it with the remarked good list 182, and further stores the purchase histories of the respective remarked goods in the purchase history data 181 and analyzes and stores purchase trends of the respective remarked goods in the analysis data 183.

The server 3 and the smart phone 1 cooperate to serve as a shopping supporting apparatus.

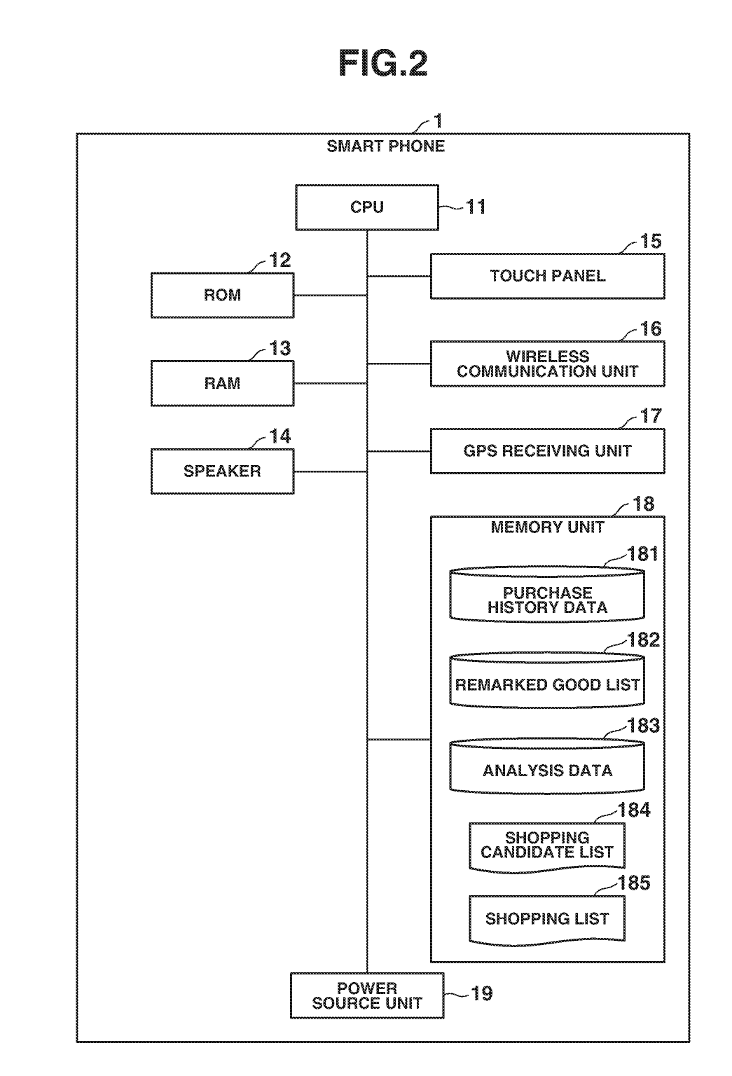

FIG. 2 is a view showing a configuration of the smart phone 1. As shown in FIG. 2, the smart phone 1 comprises CPU (Central Processing Unit) 11, ROM (Read Only Memory) 12, RAM (Random Access Memory) 13, a speaker 14, a touch panel 15, a wireless communication unit 16, GPS (Global Positioning System) receiving unit 17, a memory unit 18, and a power source unit 19.

CPU 11 composes a whole controlling unit of the smart phone 1. ROM 12 is a non-volatile area for recording various sorts of programs and data. RAM 13 is an area for temporarily storing various sorts of data to be used in calculations.

The speaker 14 serves as an information system for generating various sounds such as alarm sounds. The touch panel 15 displays operation buttons together with a browsing screen including an electronic receipt and a shopping memo. The touch panel 15 detects a tapping operation on the operation button to receive operation information. The wireless communication unit 16 communicates with the server 3 through the network 6. GPS receiving unit 17 comprises a GPS antenna and a GPS module (both, not shown), and receives GPS information through GPS antenna to calculate data indicating the current position of the smart phone 1, more specifically, data indicating the current latitude, longitude and height (hereinafter, collectively referred to as “position information”) of the smart phone 1.

The memory unit 18 consists of, for example, a flash memory, and stores the purchase history data 181, the remarked good list 182, the analysis data 183, a shopping candidate list 184, and a shopping list 185.

The shopping candidate list 184 is a list of candidate goods to be purchased, which goods the smart phone 1 extracts form the purchase histories included in the past electronic receipts. The shopping list 185 is a list of goods, which a user of the smart phone 1 manually selects to purchase.

The power source unit 19 serves to supply power to various parts of the smart phone 1.

In the memory unit 18 are installed a program relating to electronic receipts for browsing an electronic receipt on the touch panel 15 and a shopping supporting program. The program relating to electronic receipts is for the smart phone 1 to receive from the server 3 the electronic receipt which will be issued after a commercial trade is settled. The shopping supporting program is used, when a shipping memo is made and managed by the user of the smart phone 1. These programs can be downloaded into the memory unit 18, for example, through the network 6.

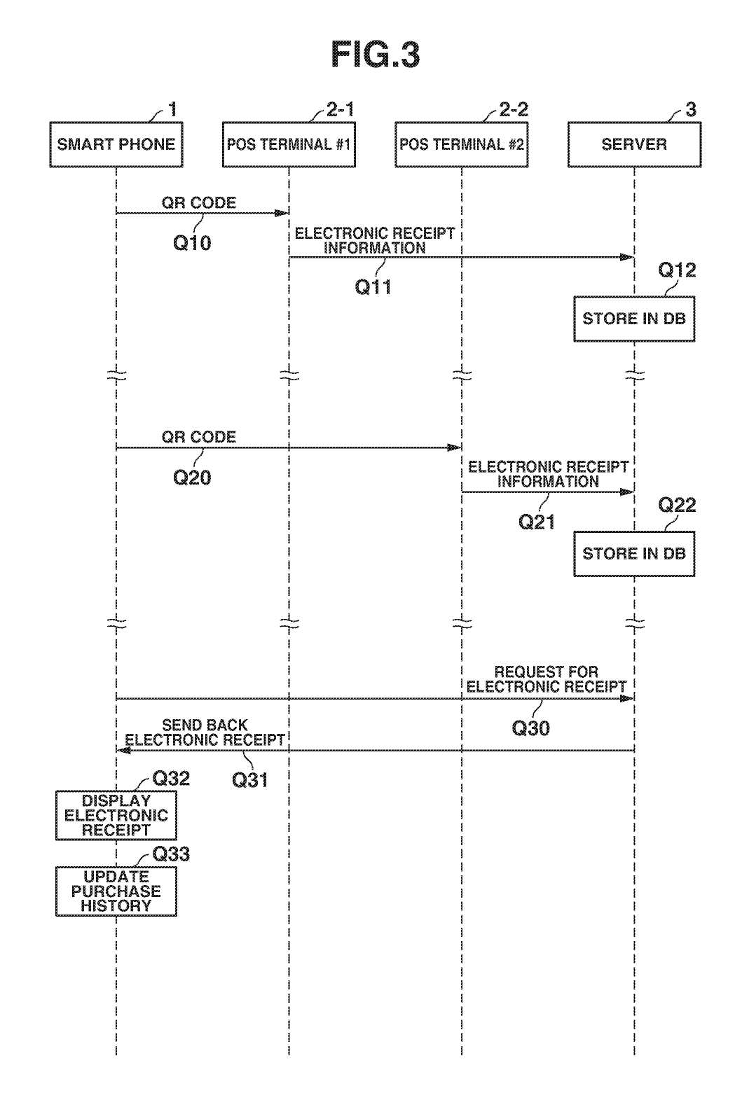

FIG. 3 is a view showing a sequence of processes for issuing an electronic receipt.

In FIG. 3, Sequences Q10 to Q12 represent a case, in which the user of the smart phone 1 has settled a commercial trade at a store, in which POS terminal 2-1 is installed.

The smart phone 1 displays QR code (Registered Trademark) on the touch panel 15, allowing POS terminal 2-1 to recognize the identification information, when the commercial trade is settled (Sequence Q10).

POS terminal 2-1 associates information of electronic receipt relating to the commercial trade with the identification information of the smart phone 1 and sends it to the server 3 (Sequence Q11). The server 3 stores the information of electronic receipt (hereinafter, “electronic-receipt information”) associated with the identification information in the electronic receipt database 31 (Sequence Q12).

Sequences Q20 to Q22 represent a case, in which the user of the smart phone 1 has settled a commercial trade at another store, in which POS terminal 2-2 is installed. The sequences Q20 to Q22 represent the case substantially the same as represented by the sequences Q10 to Q12.

Sequences Q30 to Q33 represent a case, in which the smart phone 1 downloads an electronic receipt, allowing the user to browse the electronic receipt.

The smart phone 1 sends the server 3 a request for making reference to electronic-receipt information (Sequence Q30). At this time, the smart phone 1 demands the electronic-receipt information identified by the identification information of the smart phone 1.

The server 3 selectively sends back the smart phone 1 the electronic-receipt information identified by the identification information (Sequence Q31). The smart phone 1 displays the received electronic-receipt information on the touch panel 15 (Sequence Q32). Further, the smart phone 1 updates the purchase history data 181 based on the received electronic-receipt information (Sequence Q33).

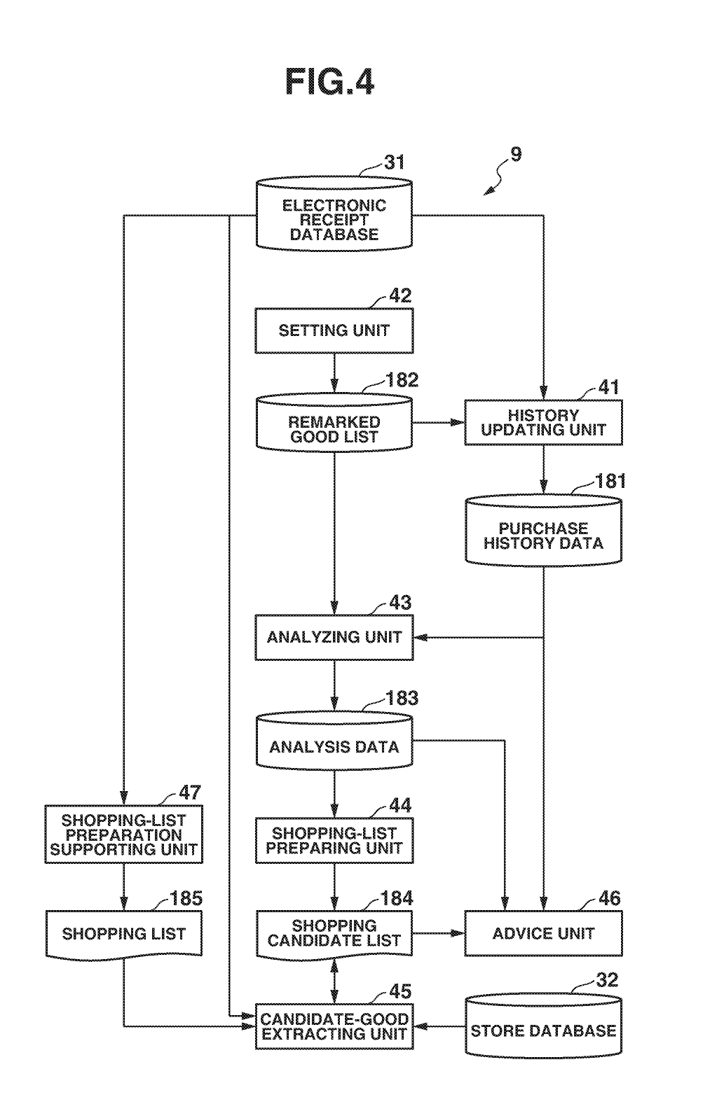

FIG. 4 is a view showing a logical composition of the electronic receipt system 9 according to the first embodiment of the invention.

When the program stored in the smart phone 1 is executed by CPU 11, a history updating unit 41, a setting unit 42, an analyzing unit 43, a shopping-list preparing unit 44, a candidate-good extracting unit 45, an advice unit 46, and a shopping-list preparation supporting unit 47 are embodied.

The history updating unit 41 serves to update the purchase history data 181 based on the electronic receipt and the remarked good list sent from the electronic receipt database 31. Then, the smart phone 1 can analyze information without being bothered by communication trouble relating to a traffic delay between the server 3 and the smart phone 1 itself.

The setting unit 42 serves to allow the user to set a remarked good list 182. The analyzing unit 43 analyzes purchase trends of the goods in the remarked good list 182 based on the purchase history data 181, and stores the analyzed purchase trends in the analysis data 183. The analyzing of the purchase trends of the goods includes calculation of statistical information such as an average value, the maximum value, the minimum value of information purchase prices, and an extracted discount pattern such as discount dates and discount hours.

Based on the purchase history data 181 and the analysis data 183, the advice unit 46 gives information of purchase prices (the average value, the maximum value, and the minimum value) of the good included in the shopping candidate list 184, and further gives the information of purchase prices of the good included in the shopping candidate list 184, which information allows the user to compare the purchase prices of the good between plural stores.

The shopping-list preparing unit 44 specifies candidate goods to be purchased based on the analysis data 183, and stores a list of the specified candidate goods in the shopping candidate list 184.

The shopping-list preparation supporting unit 47 serves to allow the user to refer to the electronic receipts sent from the electronic receipt database 31 and supports the user in manually preparing a shopping list 185.

The candidate-good extracting unit 45 extracts goods which are preferable to purchase at present from the shopping candidate list 184 and the shopping list 185. More specifically, the candidate-good extracting unit 45 extracts or decides the goods preferable to purchase at present for the reason that it is the discount day or the discount hour or it is just before closing time or the day before the closed day.

When it is determined based on the current position information and the store database 32 that the current position is close to the store designated in the shopping candidate list 184 and/or the shopping list 185, the candidate-good extracting unit 45 extracts the goods which will be better to purchase in the designated store. Further, when a new electronic receipt is sent from the electronic receipt database 31, the candidate-good extracting unit 45 extracts the goods which have been left not-purchased at the store that has issued the new electronic receipt.

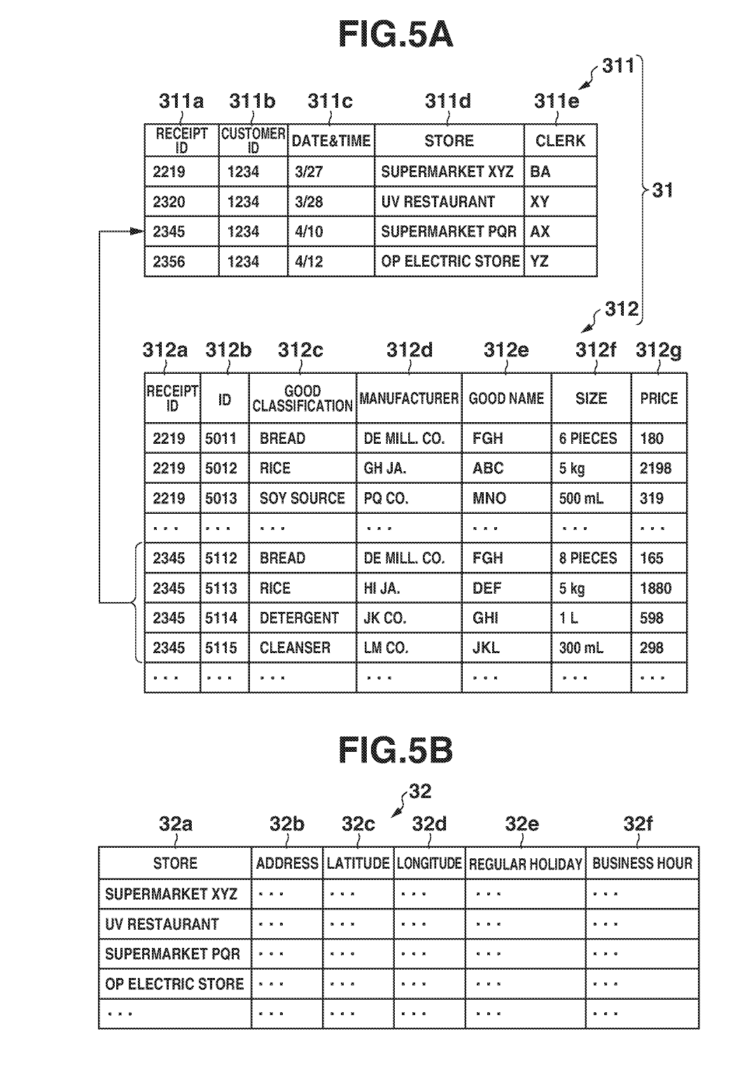

FIG. 5A and FIG. 5B are views showing the databases stored in the server 3. FIG. 5A is a view showing the electronic receipt database 31.

The electronic receipt database 31 is a relational database consisting of an electronic-receipt list database 311 combined with a purchased good database 312, wherein the electronic-receipt list database 311 includes information representing electronic receipts and the purchased good database includes information representing purchased goods on en electronic receipt. The combination of the electronic-receipt list database 311 and the purchased good database 312 will allow to easily display a list of electronic receipts and further allows to easily display the goods included in the selected electronic receipt.

As shown in FIG. 5A, the electronic-receipt list database 311 has a receipt ID column 311a, a customer ID column 311b, a date and time column 311c, a store column 311d, and a clerk column 311e.

The receipt ID column 311a stores the identification information of the electronic receipt.

The customer ID column 311b stores the identification information of the customer, to which the electronic receipt is issued. It is possible to obtain the electronic receipt of the customer by searching for the identification information of the customer through the electronic-receipt list database 311.

The date and time column 311c stores a date and time, on which an electronic receipt has been issued. The store column 311d stores the name of the store which has issued the electronic receipt. The clerk column 311e stores the name of the sales clerk who has taken charge of the commercial trade concerning the electronic receipt.

The purchased good database 312 stores various sorts of information concerning the purchased goods. As shown in FIG. 5A, the purchased good database 312 has a receipt ID column 312a, an ID column 312b, a good-classification column 312c, a manufacturer column 312d, a good-name column 312e, a size column 312f, and a price column 312g.

The receipt ID column 312a stores the identification information of the electronic receipt concerning the purchased goods. It is possible to obtain information of the goods indicated in the electronic receipt by searching for the identification information of the electronic receipt through the receipt ID column 312a.

The ID column 312b stores the identification information of the purchased good. The good-classification column 312c stores the good classification of the purchased good. The manufacturer column 312d stores a name of the manufacturer of the purchased good.

The good-name column 312e stores the name of the purchased good. The size column 312f stores information of a size of the purchased good. The price column 312g stores information of a sales price of the purchased good.

FIG. 5B is a view showing the store database 32 stored in the server 3.

The store database 32 stores information of the stores in which POS terminals 2-1, 2-2 are installed. As shown in FIG. 5B, the store database 32 has a store column 32a, an address column 32b, a latitude column 32c, a longitude column 32d, a regular holiday column 32e, and a business hour column 32f.

The store column 32a stores a names of a store, and the address column 32b stores an address of the store.

The latitude column 32c stores a latitudes of a location of the store, and the longitude column 32d stores a longitude of the location of the store. These latitude and longitude compose position information which indicates the location of the store. The smart phone 1 compares the position information with the position information obtained by GPS receiving unit 17 to detect to which store the smart phone 1 itself has come close.

The regular holiday column 32e stores regular holidays of the store, and the business hour column 32f stores the business hours of the stores. The user can determine depending on the information stored in the regular holiday column 32e and the business hour column 32f, if he or she can do shopping in that store.

FIG. 6A and FIG. 6B are views showing various sorts of data stored in the smart phone 1. FIG. 6A is a view showing the remarked good list 182 stored in the smart phone 1.

As shown in FIG. 6A, the remarked good list 182 has a good-classification column 182a, a remark flag column 182b, a store flag column 182c, a time flag column 182d, and a good-name list column 182e. The remarked good list 182 indicates the good classifications to be remarked.

The good-classification column 182a stores a good classification. The remark flag column 182b stores a flag, which indicates whether the corresponding good is to be remarked. Watching the flag, the user can restrict the purchase advice to a prescribed good classification.

The store flag column 182c stores a flag, depending on which the smart phone 1 determines whether or not it gives advice on a store at which the user should purchase the good corresponding to the good classification. The time flag column 182d stores a flag, depending on which the smart phone 1 determines whether or not it gives advice on a time at which the user should purchase the good corresponding to the good classification. The flags in the store flag column 182c and the time flag column 182d will be effective, only when the corresponding flag in the remark flag column 182b is “ON”. Depending on the flags set in the store flag column 182c and the time flag column 182d, the user can receive advice on purchase of the good under his/her desired shopping condition.

The good-name list column 182e stores lists of goods falling in the respective good classifications. For instance, when the good classification is rice, the good names written in the electronic receipts indicating “rice” issued by the respective stores are detailed in the good-name list column 182e. Referring to the good names given in the good-name list column 182e, the user detects orthographical variants in the electronic receipts issued by the respective stores and can tell whether or not the goods in the electronic receipts fall into the same good classification.

FIG. 6B is a view showing the purchase history data 181 stored in the smart phone 1.

The purchase history data 181 is purchase history data of the goods to be marked, and is generated based on the electronic receipts and the remarked good list 182. Referring to the purchase history data 181, the smart phone 1 can analyze the purchase trend of the remarked good without being bothered by communication trouble relating to a traffic delay between the server 3 and the smart phone 1 itself.

A good-classification column 181a stores the good classification of a good. The good-classification column 181a and the good-classification column 182a of the remarked good list 182 share the information (the good classifications of goods).

A date and time column 181b stores a date and time, on which an electronic receipt has been issued. A store column 181c stores the name of store which has issued the electronic receipt concerning the good.

A manufacturer column 181d stores the name of the manufacturer of the purchased good. A good-name column 181e stores the name of the purchased good. A size column 181f stores information of the size of the purchased good. A price column 181g stores information of a sales price of the purchased good.

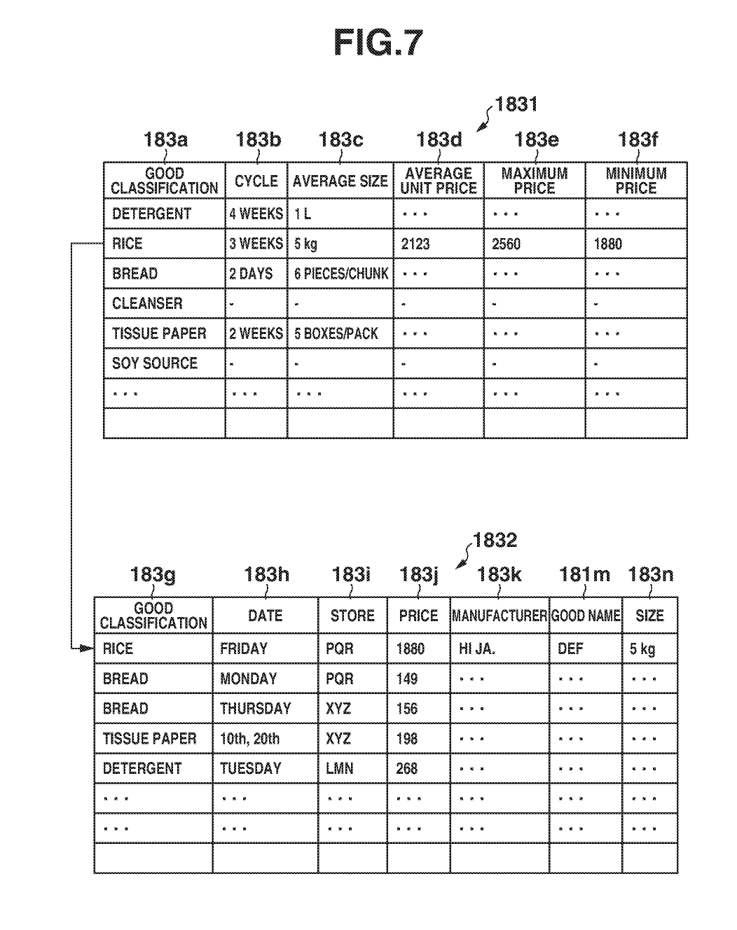

FIG. 7 is a view showing is a configuration of the analysis data 183 stored in the smart phone 1.

The analysis data 183 is a relational database consisting of statistical data 1831 combined with advice data 1832, wherein the statistical data 1831 represents a result of analysis of the purchase trends of the remarked goods, and the advice data 1832 is used to give advice on preferable purchase of goods.

As shown in FIG. 7, the statistical data 1831 has a good-classification column 183a, a cycle column 183b, an average size column 183c, an average unit price column 183d, a maximum price column 183e, and a minimum price column 183f.

The good-classification column 183a stores the good classification of the remarked good. The good-classification column 183a and the good-classification column 182a of the remarked good list 182 share the information (the good classifications of goods).

The cycle column 183b stores a purchase cycle of the remarked good. The average size column 183c stores a size, weight, and units of the remarked good.

The average unit price column 183d stores an average of the purchase prices at which the user purchased the remarked good in the past. The maximum price column 183e stores the highest price at which the user purchased the remarked good in the past. The minimum price column 183f stores the lowest price at which the user purchased the remarked good in the past.

The statistical data 1831 is produced as a result of statistical analysis of the purchase history data 181 performed by the analyzing unit 43, in other words, the analyzing unit 43 statistically analyzes the purchase history data 181 to produce the statistical data 1831. The statistical data 1831 allows the smart phone 1 to give the user advice on the purchase price of each of the remarked goods.

The advice data 1832 includes various sorts of information relating to discount sales performed periodically. For instance, the advice data 1832 has a good-classification column 183g, a date column 183h, a store column 183i, a price column 183j, a manufacturer column 183k, a good-name column 183m, and a size column 183n.

The good-classification column 183g stores the good classification of the remarked good put on the periodical discount sales. The good-classification column 183g and the good-classification column 183a share the information.

The date column 183h stores information of the day of the week or dates on which the periodical discount sale is performed.

The store column 183i stores information of the store at which the periodical discount sales are performed.

The price column 183j stores price information of the remarked good on the periodical discount sales. The manufacturer column 183k stores information of the manufacturer of the remarked good.

The good-name column 183m stores information of good names of the remarked goods on the periodical discount sales. The size column 183n stores information of a size, weight and units of the remarked good.

The advice data 1832 is produced as a result of analysis of the purchase history data 181 performed by the analyzing unit 43, in other words, the analyzing unit 43 analyzes the purchase history data 181 to produce the advice data 1831. The advice data 1832 allows the smart phone 1 to give the user advice on the periodical discount sales of the remarked good.

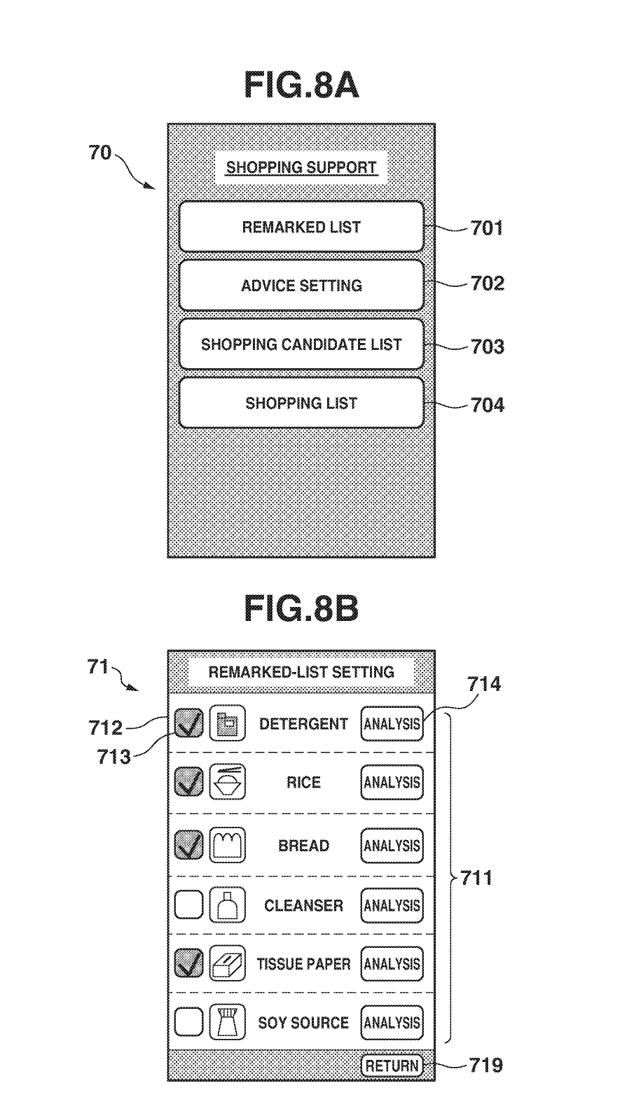

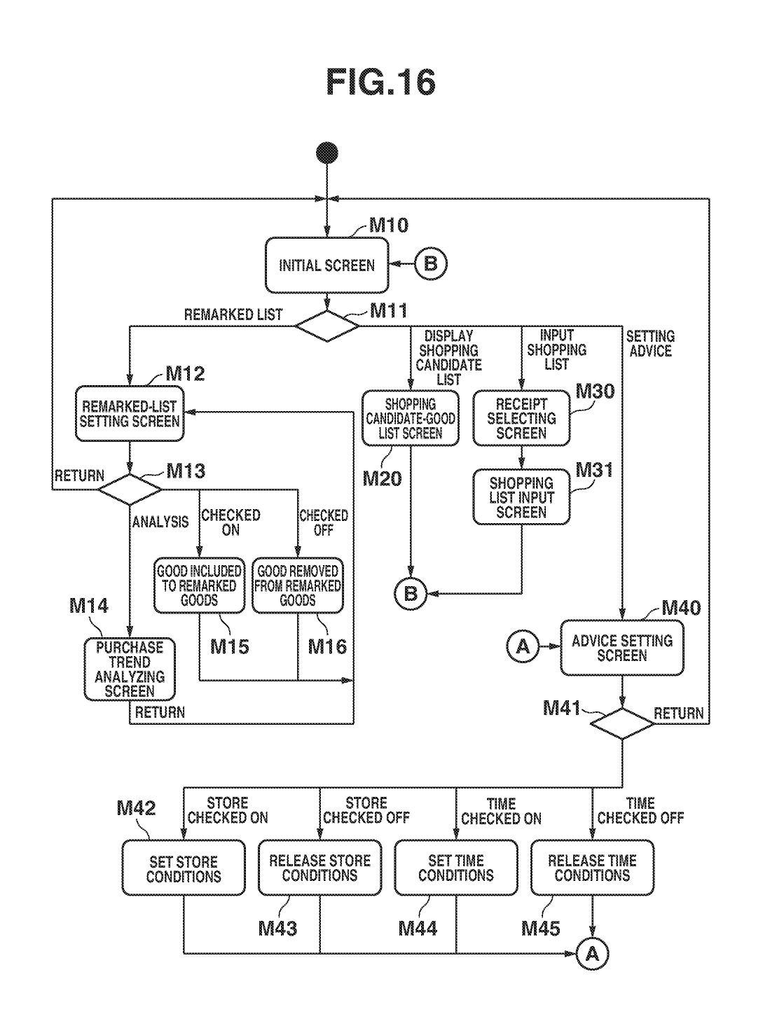

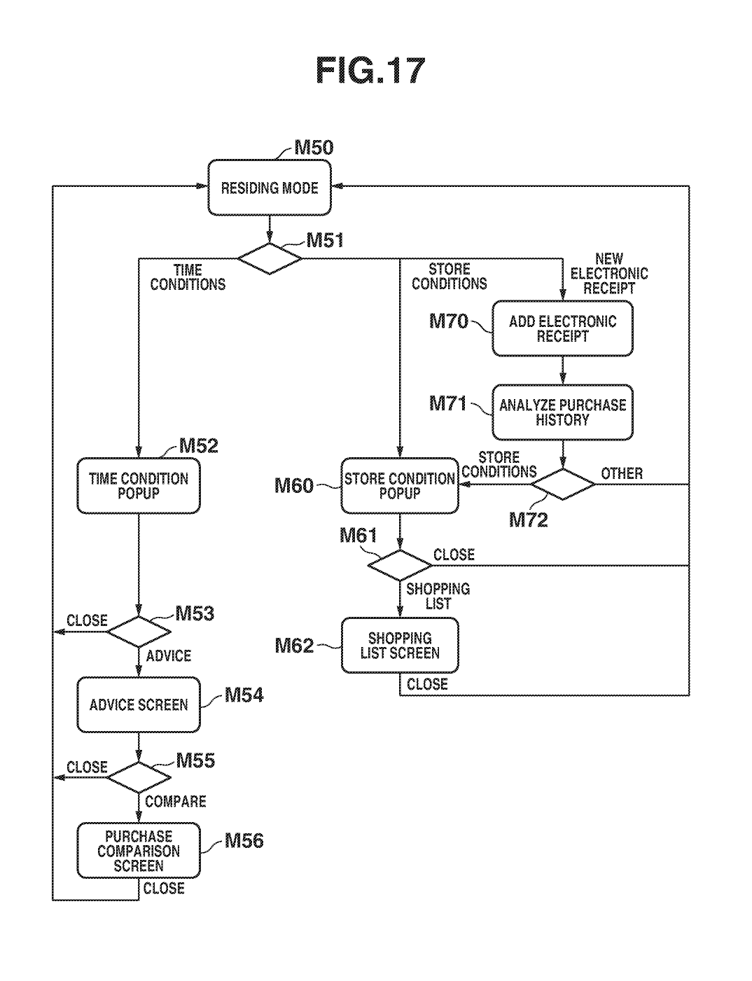

Hereinafter, various screens of the shopping supporting program will be explained with reference to FIG. 8A to FIG. 15. A mode transition of the shopping supporting program will be explained with reference to FIG. 16 and FIG. 17.

FIG. 8A is a view showing an initial screen 70 of the shopping supporting program. FIG. 8B is a view showing a screen 71 for setting the remarked good list (Hereinafter, the “remarked-good list setting screen” 71).

The initial screen 70 shown in FIG. 8A is displayed at the time when the shopping supporting program starts. In the initial screen 70, a remarked list button 701, an advice setting button 702, a shopping-candidate list displaying button 703, and a shopping-list input button 704 are indicated for a tapping operation.

The remarked list button 701 is used to display a current list of remarked goods and also is used to add and/or delete a remarked good to/from the current list of remarked goods. When the remarked list button 701 is tapped, the smart phone 1 transits from the initial screen 70 to the remarked-list setting screen 71 (Refer to FIG. 8B).

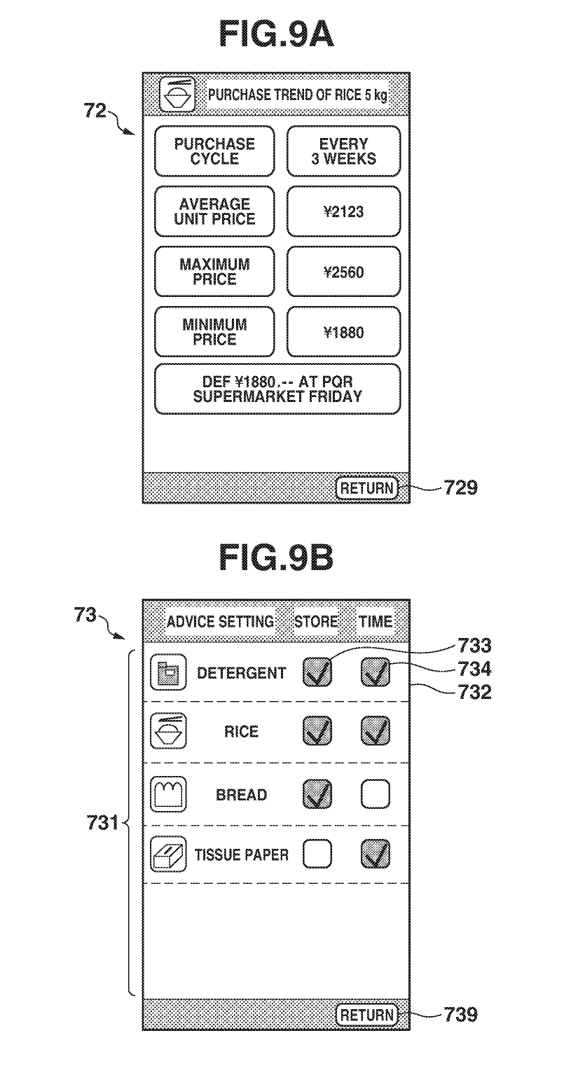

The advice setting button 702 is used to set in which way advice is given on the current remarked good. When the advice setting button 702 is tapped, the smart phone 1 transits from the initial screen 70 to an advice setting screen 73 (Refer to FIG. 9B).

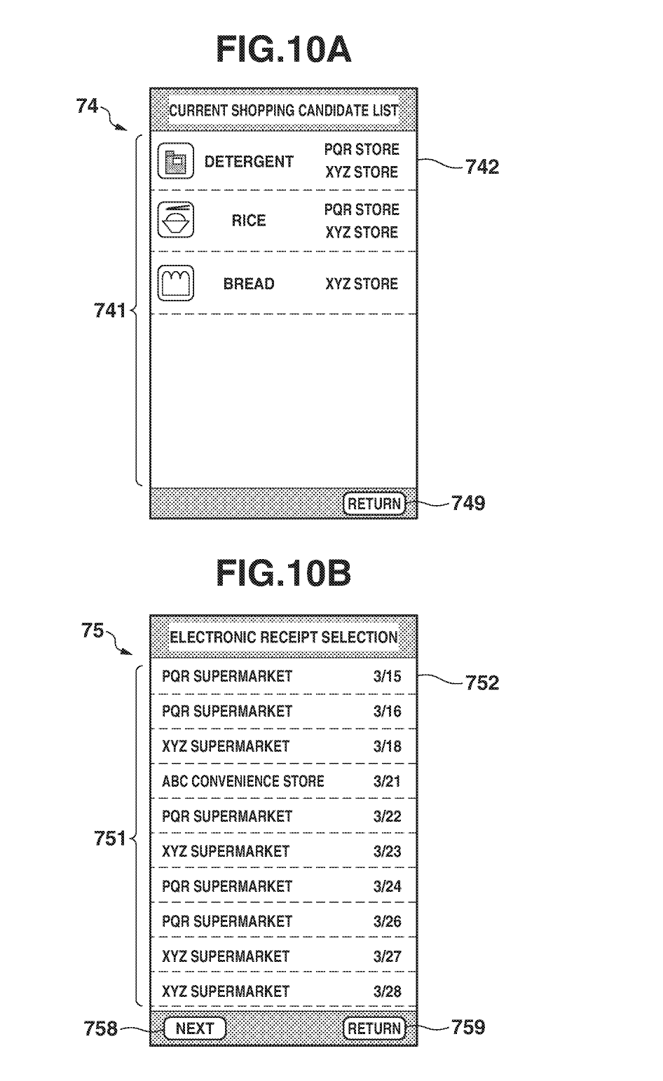

The shopping-candidate list displaying button 703 is used to display the candidates for goods to be included in the current shopping list. When the shopping-candidate list displaying button 703 is tapped, the smart phone 1 transits from the initial screen 70 to a shopping candidate-good list screen 74 (Refer to FIG. 10A).

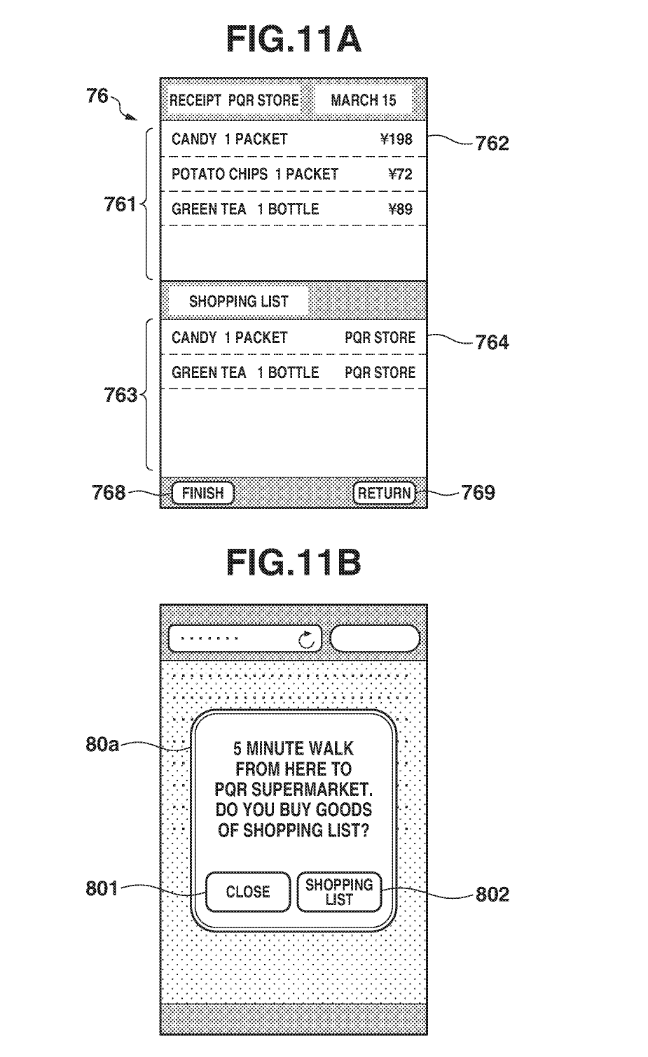

The shopping-list input button 704 is used to enter a new shopping list. When the shopping-list input button 704 is tapped, the smart phone 1 transits from the initial screen 70 to a receipt selecting screen 75 (Refer to FIG. 10B) and a shopping list input screen 76 (Refer to FIG. 11A).

The remarked-list setting screen 71 (shown in FIG. 8B) indicates the current list of remarked goods, and is used to add and/or delete a remarked good to/from the current list of remarked goods. The setting unit 42 (FIG. 4) displays the remarked-list setting screen 71.

As shown in FIG. 8B, the remarked-list setting screen 71 indicates a remarked-good list 711 including arranged remarked-good rows 712, and a return button 719 for returning to the prior screen, when tapped. Each remarked-good row 712 includes or indicates a check box 713 to be checked to indicate whether or not the corresponding good is to be remarked, an icon of the corresponding good, the good name, and an analysis button 714 for analyzing and displaying purchase trend of the corresponding good.

The remarked-list setting screen 71 consists of a part of the remarked good list 182 (FIG. 6A) which is displayed by the setting unit 42 (FIG. 4).

The check box 713 is operated by toggles. Therefore, when the check box 713 with no “check mark” put is tapped, then the check mark will be put in the check box 713, and when the check box 713 with the check mark put is tapped, then the check mark will disappear from check box 713. When the check mark is put in the check box 713, the purchase history of the remarked good is accumulated and analyzed, and advice on the remarked good is given. The check mark put in the check box 713 has an influence on the remark flag column 182b of the remarked good list 182.

The analysis button 714 is used to analyze the purchase trend of the corresponding good. When the analysis button 714 is tapped, the smart phone 1 transits from the remarked-list setting screen 71 to a purchase-trend analyzing screen 72.

FIG. 9A is a view showing the purchase-trend analyzing screen 72. FIG. 9B is a view showing an advice setting screen 73.

The purchase-trend analyzing screen 72 shown in FIG. 9A shows a result of the analysis of the purchase trend of the good of “rice”. The advice unit 46 (FIG. 4) displays this purchase-trend analyzing screen 72. The purchase-trend analyzing screen 72 indicates the user's purchase cycle of rice, the average unit price, maximum price, and minimum price for the size of 5 Kg, which size the user purchases most frequently in the past. Further, the purchase-trend analyzing screen 72 indicates the purchase advice of rice, “Rice “DEF”, ¥1880. - - - at the “PQR” supermarket on Friday”. “DEF” indicates a brand of the rice. The purchase-trend analyzing screen 72 represents the analysis data 183 (Refer to FIG. 7).

The advice setting screen 73 shown in FIG. 9B is a screen used to set a way of giving advice on the current remarked good. The setting unit 42 displays this advice setting screen 73. The advice setting screen 73 indicates an advice setting list 731 including arranged remarked-good rows 732, and a return button 739 for returning to the prior screen, when tapped. Each remarked-good row 732 includes or indicates an icon of the corresponding good, the good name, a store check box 733 to be checked to indicate advice on the store where the good should be purchased, and a time check box 734 to be checked to indicate advice on a time when the good should be purchased.

The advice setting screen 73 consists of a part of the remarked good list 182 (FIG. 6A) which is displayed by the setting unit 42 (FIG. 4). The store check box 733 indicates the store flag column 182c of the remarked good list 182 (FIG. 6A). The time check box 734 indicates the time flag column 182d of the remarked good list 182 (FIG. 6A). The store check box 733 and the time check box 734 are operated by toggles.

FIG. 10A is a view showing the shopping candidate-good list screen 74, and FIG. 10B is a view showing the receipt selecting screen 75.

The shopping candidate-good list screen 74 shown in FIG. 10A is a screen indicating candidate goods to be purchased. The shopping candidate-good list screen 74 indicates a shopping list 741 including arranged candidate good rows 742, and a return button 749 for returning to the prior screen, when tapped. Each good row 742 includes or indicates an icon of the corresponding good, the good name, and the store names where the good was purchased in the past.

The shopping-candidate good list screen 74 consists of the displayed shopping candidate list 184 (FIG. 4). Based on the purchase history data 181 and the remarked good list 182 (FIG. 6), the smart phone 1 specifies the good classification which has been actually purchased periodically, and extracts goods to be purchased this time from the specified good classification.

The receipt selecting screen 75 shown in FIG. 10B is a screen for selecting a receipt to be referred, based on which screen the user manually creates a new shopping list. The receipt selecting screen 75 has a receipt list 751 including arranged receipt rows 752, a next button 758 for moving to the shopping list input screen 76, and a return button 759 for returning to the prior screen, when tapped. Each receipt row 752 includes a store and a date. The receipt selecting screen 75 represents the electronic receipt database 31 (FIG. 5) stored in the server 3.

FIG. 11A is a view showing the shopping list input screen 76. FIG. 11B is a view showing a screen indicating store-conditions in a popup 80a (hereinafter, the “store-condition popup”).

The shopping list input screen 76 shown in FIG. 11A is a screen for manually creating a new shopping list. The shopping list input screen 76 indicates a purchase good list 761, a shopping list 763, a finish button 768, a return button 769 for returning to the prior screen, when tapped.

The purchase good list 761 includes arranged purchase good rows 762. The shopping list 763 includes arranged candidate good rows 764. When either of the purchase good rows 762 is dragged to the shopping list 763, the contents of the dragged purchase good row 762 are included to the candidate good row 764. When the finish button 768 is tapped, the smart phone 1 finishes creating the shopping list 763 and reflects the created shopping list 763 to the shopping list 185 (FIG. 2), returning to the initial screen 70.

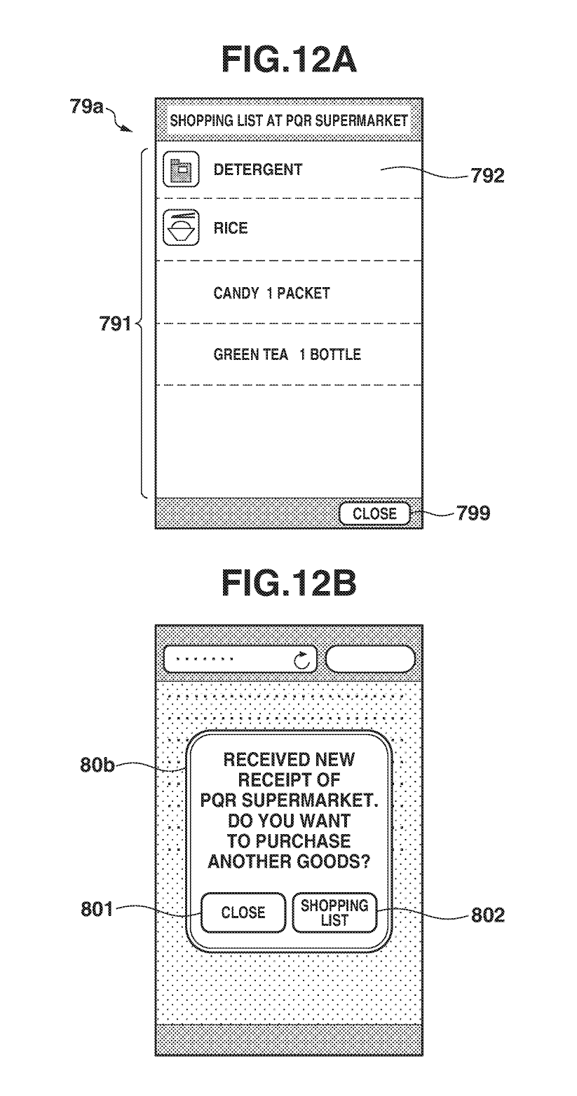

The store-condition popup 80a shown in FIG. 11B is a screen which tells that the smart phones 1 has come close to either of the stores included in the shopping candidate list 184 (FIG. 2) and/or the shopping list 185 (FIG. 2). The store-condition popup 80a shown in FIG. 11B gives notice that it is 5 minutes walk from here to the “PQR” supermarket, at which the candidate good is available. The store-condition popup 80a is displayed, even while other application program is being executed. When the process for creating and/or setting a memo has been finished, the shopping supporting program resides in the smart phone 1 to display the store-condition popup 80a satisfying a prescribed conditions, in the case where said conditions are met. The store-condition popup 80a includes a close button 801 for closing the popup 80a and a shopping list button 802 for indicating the current shopping candidate list 184, and the current shopping list 185. When the shopping list button 802 is tapped, the smart phones 1 closes the store-condition popup 80a and transits to a shopping list screen 79a (Refer to FIG. 12A).

FIG. 12A is a view showing the shopping list screen 79a. FIG. 12B is a view showing another store-condition popup 80b.

The shopping list screen 79a shown in FIG. 12A is a screen indicating candidate goods extracted to be purchased. The shopping list screen 79a indicates a shopping list 791 including arranged candidate good rows 792, and a close button 799 for closing the shopping list screen 79a. The shopping list screen 79a has an indication of “Shopping List at PQR supermarket”. Each good row 792 includes or indicates an icon of the corresponding good, and the good name.

The shopping list screen 79a represents the shopping candidate list 184 (FIG. 4) and the shopping list 185 (FIG. 4). Based on the purchase history in the electronic receipt database 31, the smart phone 1 specifies the goods which have been actually purchased periodically, and extracts goods to be purchased this time from the specified goods, displaying a list of the specified goods together with the shopping list 185.

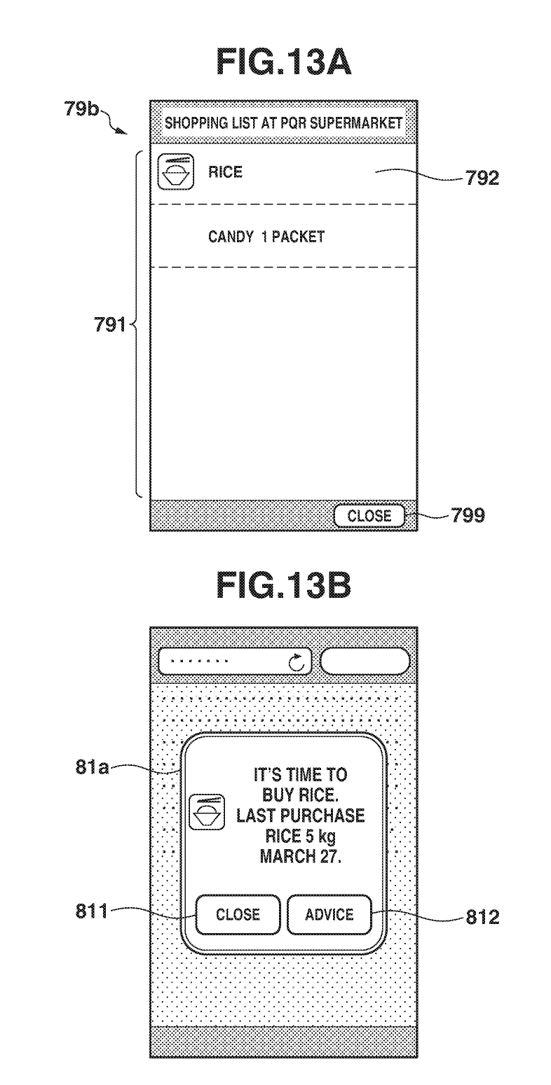

The store-condition popup 80b shown in FIG. 12B is prepared for giving notice of the good that the user forgets to buy at the store, when the user has received an electronic receipt. The store-condition popup 80b is displayed, even while other application program is being executed. The store-condition popup 80b includes the close button 801 for closing the popup 80b and the shopping list button 802 for displaying the current shopping candidate list 184 and the current shopping list 185. When the shopping list button 802 is tapped, the smart phones 1 closes the store-condition popup 80b and transits to a shopping list screen 79b (Refer to FIG. 13A).

FIG. 13A is a view showing the shopping list screen 79b. FIG. 13B is a view showing a time-condition popup 81a.

The shopping list screen 79b shown in FIG. 13A is a screen for indicating the good (s) that the user forgot to buy. The shopping list screen 79b indicates the shopping list 791 including the arranged candidate good rows 792, and the close button 799 for closing the shopping list screen 79b. Each candidate good row 792 includes or indicates an icon of the corresponding good, the good name, and the store where the user bought the good in the past.

The shopping list screen 79b represents the shopping candidate list 184 (FIG. 4) and the shopping list 185 (FIG. 4). Upon receipt of a new electronic receipt from the electronic receipt database 31, the smart phone 1 deletes the purchased goods from the shopping candidate list 184 and the shopping list 185 to extract the goods that the user forgot to buy.

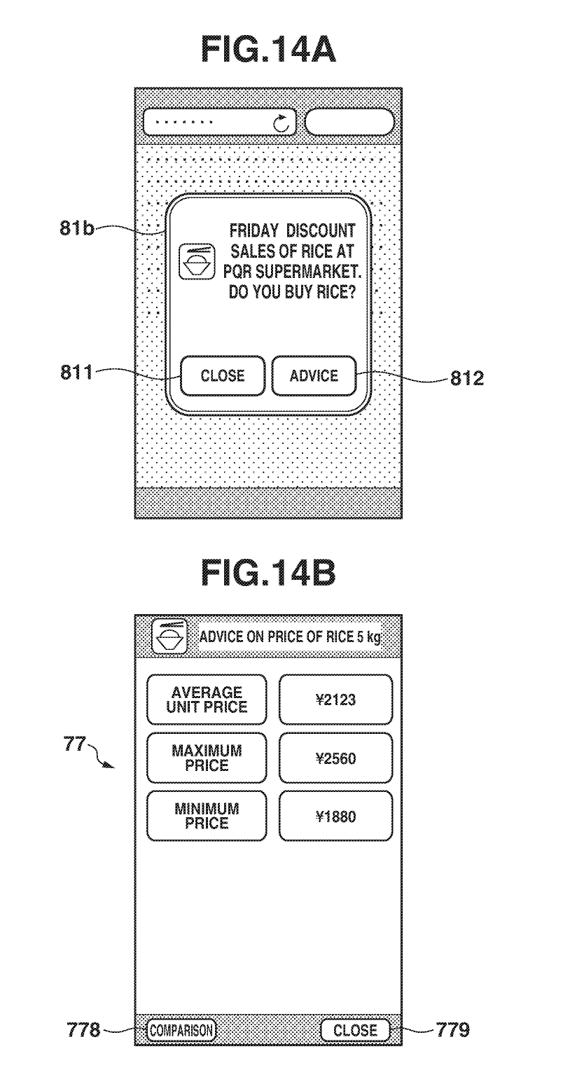

The time-condition popup 81a shown in FIG. 13B is a screen for giving notice that a time for buying a good has come, and giving notice of the last purchase date of “March 27” and the purchased amount of “5 Kg.” Further, the time-condition popup 81a indicates a close button 811 for closing the popup 81a and an advice button 812 for giving advice on the noticed good. When advice button 812 is tapped, the smart phone 1 closes the time-condition popup 81a and transits to an advice screen 77 (Refer to FIG. 14B).

FIG. 14A is a view showing another time-condition popup 81b. FIG. 14B is a view showing the advice screen 77.

The time-condition popup 81b shown in FIG. 14A is a screen for giving notice that it is a preferable day for buying the good since today is a discount day, and also for giving notice that “PQR” supermarket sells the good of “rice” at a discount. Further, the time-condition popup 81b indicates the close button 811 for closing the popup 81b, and the advice button 812 for giving advice on the noticed good. When advice button 812 is tapped, the smart phone 1 closes the time-condition popup 81b and transits to the advice screen 77 (Refer to FIG. 14B).

The advice screen 77 shown in FIG. 14B is a screen for giving notice of the purchase price at which the good was bought in the past, wherein the purchase price was already displayed by the time-condition popups 81a and 81b. The advice unit 46 displays the average unit price, the maximum price, and minimum price of the good on the advice screen 77. Further, the advice screen 77 indicates the analysis data 183.

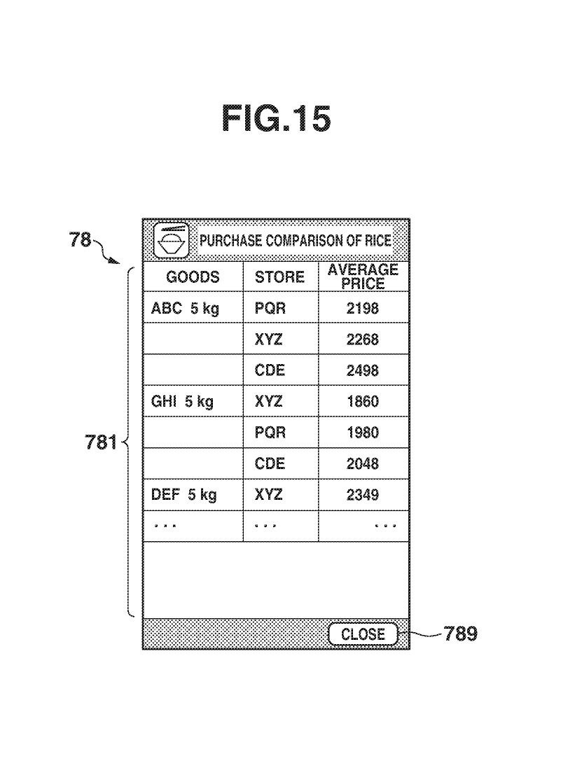

The advice screen 77 has a comparison button 778 for comparing the purchase prices of the good among the plural stores, and a close button 779 for closing the advice screen 77. When the comparison button is tapped, the smart phone 1 transits to a purchase comparison screen 78 (Refer to FIG. 15). Using the purchase comparison screen 78, the smart phone 1 gives advice on whether or not the user should purchase the expected good at the current price.

FIG. 15 is a view showing the purchase comparison screen 78.

The purchase comparison screen 78 shown in FIG. 15 is a screen for comparing the purchase prices of the good among the plural stores, which prices were displayed on the time-condition popups 81a and 81b. The advice unit 46 displays the good names, the store names, and the average purchase prices of the goods on the purchase comparison screen 78. Further, the purchase comparison screen 78 has a close button 789 for closing the purchase comparison screen 78. Using the purchase comparison screen 78, the smart phone 1 gives advice on at which store the user should purchase the expected good.

FIG. 16 is a view showing a mode transition of the shopping supporting program.

When the shopping supporting program starts, the initial screen 70 (FIG. 8A) is displayed at first (Mode M10). When any button indicated in the initial screen 70 is tapped, the process corresponding to the tapped button will be performed (Mode M11).

When the remarked list button 701 is tapped in the mode M11, the smart phone 1 transits to the remarked-list setting screen 71 (FIG. 8B) (Mode M12).

When the shopping-candidate list displaying button 703 is tapped in the mode M11, the smart phone 1 specifies the goods which have been actually purchased periodically from the electronic receipt database 31 and the remarked good list 182 and further extracts the goods to be purchased this time from the specified goods, transiting to the shopping candidate-good list screen 74 (FIG. 10A) (Mode M20), thereafter, returning to the initial screen 70 (Mode M10).

When the shopping-list input button 704 is tapped in the mode M11, the smart phone 1 transits to the receipt selecting screen 75 (FIG. 10) (Mode M30), further transiting to the shopping list input screen 76 (FIG. 11A) (MODE M31), thereafter returning to the initial screen 70 (Mode M10).

When the advice setting button 702 is tapped in the mode M11, the smart phone 1 transits to the advice setting screen 73 (FIG. 9B) (Mode M40).

### Mode Transition after Remarked-list Setting Screen 71

In the remarked-list setting screen 71 (FIG. 8B) (Mode M12), when either of the buttons is tapped, or when either of the check boxes is checked on (a check mark is put in the box) or checked off (a check mark is deleted from the box), a process corresponding to the tapping or checking operation will be performed (Mode M13).

When the analysis button 714 is tapped in the mode M13, the smart phone 1 transits to the purchase trend analyzing screen 72 (FIG. 9A) (Mode M14). Referring to the purchase-trend analyzing screen 72, the user can understand the purchase-trend of a new remarked good.

When the check box 713 is checked on (a check mark is put), the good corresponding to the checked-on box is remarked (Mode M15), and when the check box 713 is check off (a check mark is deleted), the good corresponding to the checked-off box is removed from the remarked goods (Mode M16) , thereafter the screen returns to the remarked-list setting screen 71. In this way, the advice will be given only to the restricted goods. When the return button 719 is tapped in the mode M12, the smart phone 1 returns to the initial screen 70 (Mode M10).

When the return button 729 indicated in the purchase-trend analyzing screen 72 (FIG. 9A) (Mode M14) is tapped, the smart phone 1 returns to the remarked-list setting screen 71 (Mode M12).

### Mode Transition after Advice Setting Screen 73

In the advice setting screen 73 (FIG. 9B) (Mode M40), when either of the buttons is tapped, or when either of the check boxes is checked on (a check mark is put in the box)) or checked off (a check mark is removed from the box), a process corresponding to the tapping or checking operation will be performed (Mode M41).

When the store check box 733 is checked on, store conditions are set (Mode M42), and when the store check box 733 is checked off, the store conditions are released (Mode M43). When the store conditions are set, the advice unit 46 extracts the goods to purchase at respective stores and gives an advice on the goods to purchase at the stores, before and/or after purchase at the respective stores.

Further, when the time check box 734 is checked on, time conditions are set (Mode M44), and when the time check box 734 is checked off, the time conditions are released (Mode M45). When the time conditions are set, the advice unit 46 extracts the goods to purchase at present and gives an advice on the goods to purchase at present. The goods to purchase at present include the goods which are to be purchased at present in terms of the past purchase cycle and the goods available at a discount or point-up sales at either of the stores at present.

When the return button 719 is tapped, the smart phone 1 returns to the initial screen 70 (Mode M10).

FIG. 17 is a view showing a mode transition, while the shopping supporting program permanently resides.

In the permanently residing mode (Mode M50), the shopping supporting program repeatedly judges based on the shopping candidate list 184 and the shopping list 185 whether the time conditions and the store conditions are satisfied, and also repeatedly judges if a new electronic receipt has been received (Mode M51).

When it is determined that the time conditions are satisfied in the shopping candidate list 184 or the shopping list 185 (Mode M51), the advice unit 46 indicates either of the time condition popups 81a and 81b (FIG. 13B, FIG. 14A) (Mode M52). When either of the buttons of the time condition popups 81a and 81b is tapped, a process corresponding to the tapped button will be performed (Mode M53).

When the close button 811 is tapped in the mode M53, the smart phone 1 closes the popup, returning to the residing mode (Mode M50). Meanwhile, when the advice button 812 is tapped in the mode M53, the smart phone 1 transits to the advice screen 77 (FIG. 14B) (Mode M54). When either of the buttons of the advice screen 77 is tapped, a process corresponding to the tapped button will be performed (Mode M55).

When the close button 779 is tapped in the mode M55, the smart phone 1 closes the advice screen 77, returning to the residing mode (Mode M50). Meanwhile, when the comparison button 778 is tapped in the mode M55, the smart phone 1 transits to the purchase comparison screen 78 (FIG. 15) (Mode M56).

Further, when the close button 789 is tapped in the purchase comparison screen 78 of the mode M56, the smart phone 1 closes the purchase comparison screen 78, returning to the residing mode (Mode M50).

When it is determined that the store conditions are satisfied in the shopping candidate list 184 or the shopping list 185 (Mode M51), the advice unit 46 indicates either of the store condition popups 80a and 80b (FIG. 11B, FIG. 12B) (Mode M60). Before purchasing the goods at the store, the smart phone 1 can give notice of a list of the goods to purchase at the store. When either of the buttons of the store condition popups 80a and 80b is tapped, a process corresponding to the tapped button will be performed (Mode M61).

When the close button 801 is tapped in the mode M61, the smart phone 1 closes the popup, returning to the residing mode (Mode M50). Meanwhile, when the shopping list button 802 is tapped in the mode M61, the smart phone 1 transits to either of the shopping list screens 79a and 79b (FIG. 12A, FIG. 12B) (Mode M62). When the close button 799 is tapped in the shopping list screen 79b, the smart phone 1 closes the shopping list screens 79a or 79b, returning to the residing mode (Mode M50).

When a new electronic receipt has been received (in the mode M51, the purchase history of the remarked good included in the received electronic receipt is added to the purchase history data 181 (Mode M70), and the purchase history data 181 is analyzed (Mode M71). Further, the shopping supporting program judges whether the store which has issued the electronic receipt satisfies the store conditions given in the shopping candidate list 184 and/or the shopping list 185 (Mode M72).

When the store which has issued the electronic receipt satisfies the store conditions given in the shopping candidate list 184 and/or the shopping list 185, the advice unit 46 indicates either of the store condition popups 80a and 80b) (Mode M60). When the store does not satisfy the store conditions, the smart phone 1 returns to the residing mode (Mode M50). Then, after purchasing the goods at the store, the smart phone 1 can give notice of a list of additional goods to be purchased at the store.

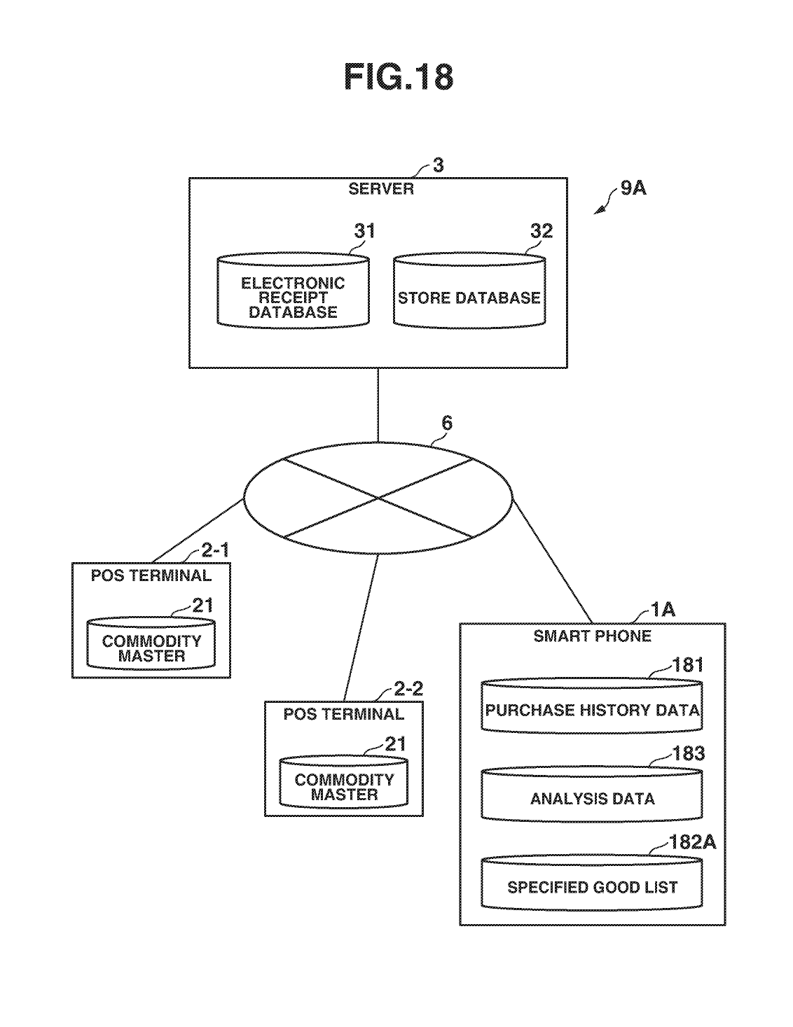

FIG. 18 is a view schematically showing a configuration of the electronic receipt system 9A according to the second embodiment of the invention. In FIG. 18, like elements as those in the electronic receipt system 9 shown in FIG. 1 are designated by like reference numerals and their description is omitted there.

In the electronic receipt system 9A according to the second embodiment, the smart phone 1A stores a specified good list 182A in place of the remarked good list 182 of the first embodiment. Excluding the specified good list 182A, the electronic receipt system 9A has substantially the same configuration as the electronic receipt system 9 according to the first embodiment of the invention.

The specified good list 182A is a list of specified goods which have been purchased periodically and are extracted from the purchase history in the electronic receipt database 31. Using the good specifying list 182A, the shopping candidate list 184, or a list of the candidate goods to be purchased, can be created without referring to the remarked good list 182.

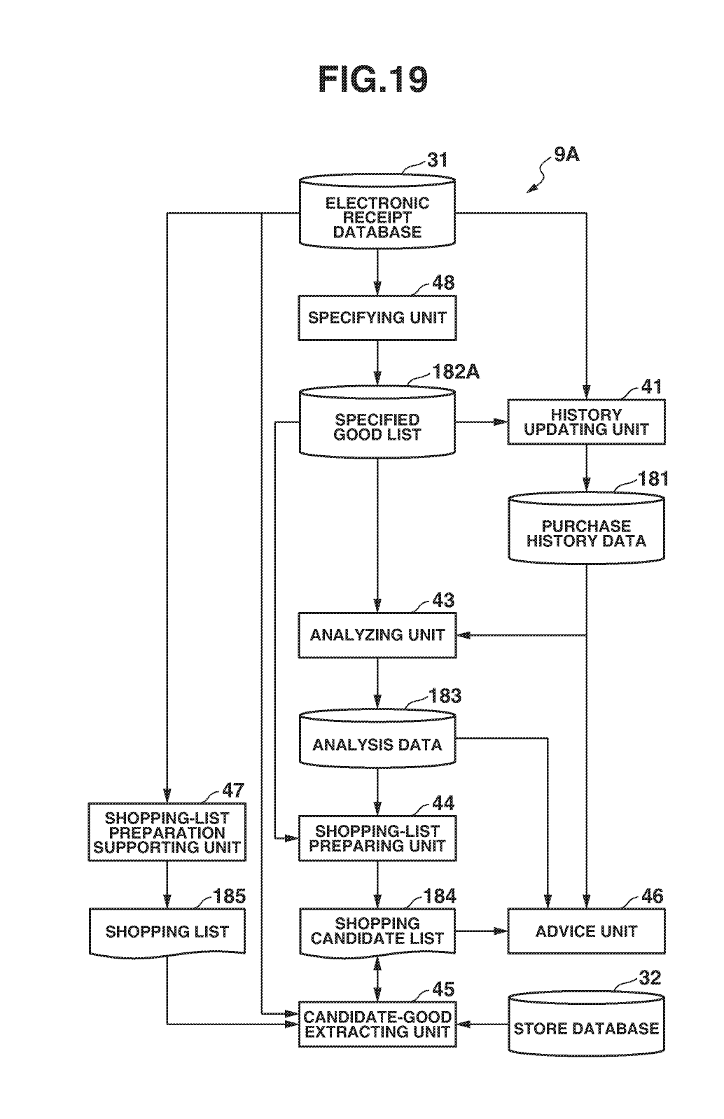

FIG. 19 is a view showing the logical composition of the electronic receipt system 9A according to the second embodiment of the invention. In FIG. 19, like elements as those in the electronic receipt system 9 shown in FIG. 4 are designated by like reference numerals and their description is omitted there.

The electronic receipt system 9A according to the second embodiment is provided with a specifying unit 48 in place of the setting unit 42 in the first embodiment, and stores the specified good list 182A in place of the remarked good list 182 of the first embodiment. Excluding the specifying unit 48 and the specified good list 182A, the electronic receipt system 9A has substantially the same configuration as the electronic receipt system 9 according to the first embodiment of the invention.

The specifying unit 48 specifies the goods which have been actually purchased periodically on the basis of the purchase history of the electronic receipt database 31, and stores the specified goods in the specified good list 182A. Using the specified good list 182A, the smart phone 1 can create the shopping candidate list 184 without referring to the remarked good list 182 and can give advice on the purchase time and the store to buy the goods. The specifying unit 48 specifies the goods depending on whether the goods have been purchased periodically or not. The goods can be specified if they were purchased frequently but not periodically.

It is possible to extract goods purchased at shops on the network in the past and/or goods of a large purchase amount as the goods to be specified, and to give a customer advice to purchase such extracted goods. But even if an advice is given to the customer to purchase goods which were purchased irregularly as the candidate goods, such advice will not be helpful for the customer, putting the customer to inconvenience.

If the customer understands that the good has been purchased periodically and frequently, it will be extremely useful for the customer to give advice to purchase such good and/or to give advice on the time to purchase such good.

### The Modified Embodiment of the Invention

Although specific configurations of the invention have been described in the above detailed description, it will be understood that the invention is not limited to the particular embodiments described herein, but modifications and rearrangements may be made to the disclosed embodiments while remaining within the scope of the invention as defined by the following claims. For instance, it is intended to include all the following modifications and rearrangements (a) to (c) in the following claims and their equivalents:

(a) For instance, it is possible for the smart phone and POS terminal to directly exchange the electronic receipt to each other through a near-field wireless communication system without through the server;

(b) In the first embodiment, notation variability of the good names on the electronic receipt are subjected to name identification in the good-name list column 182e of the remarked good list 182. But other process will be employed, such that a name identification database of the good names may be stored in the server 3 for that purpose; and

(c) In the second embodiment, it is possible for a shopping-list preparing unit 44 to prepare the shopping candidate list 184 not based on the analysis data 183 but on the good specifying list 182A.

What is claimed is:

1. A shopping supporting apparatus of a portable type, comprising:
a receiving unit which receives an electronic receipt when a user of the apparatus has purchased goods at a store, which receipt clearly indicates a payment amount of the purchased goods and store information of the store at which the user has purchased the goods;
a receipt memorizing unit which memorizes plural electronic receipts received by the receiving unit as history information of the electronic receipts;
a list memorizing unit which allows the user to create and memorize a list of plural goods to be remarked, wherein the list of plural goods is a commodity list created by the user at his/her arbitrary option;
an extracting unit which refers to the history information of the electronic receipts to extract a candidate good to be purchased at present or at a present position from among plural goods included in the commodity list; and
a displaying unit which displays the candidate good extracted by the extracting unit.

2. The shopping supporting apparatus according to claim 1, wherein
when a store which sells a good included in the plural goods of the commodity list is involved among the stores located close to the present position of the shopping supporting apparatus, the extracting unit extracts as the good to be purchased said good which is sold at the store located close to the present position of the shopping supporting apparatus.

3. The shopping supporting apparatus according to claim 1, further comprising:
an obtaining unit which refers to the plural electronic receipts memorized in the receipt memorizing unit to obtain store information of the store at which the good included in the plural goods of the commodity list has been purchased actually, and wherein
the displaying unit displays the candidate good extracted by the extracting unit together with the store information obtained by the obtaining unit.

4. The shopping supporting apparatus according to claim 1, wherein
the list memorizing unit selects a good to be remarked from among the goods indicated in the plural electronic receipts memorized in the receipt memorizing unit to memorize the commodity list as the good to be remarked, including the selected good and the store information of the store where the good has been purchased; and
the extracting unit extracts from among the plural goods included in the commodity list, a good which memorizes a store located close to the present position of the shopping supporting apparatus to purchase the good as the good to be purchased.

5. The shopping supporting apparatus according to claim 1, wherein
the extracting unit refers to the history information of the electronic receipts to judge whether or not any good has been purchased periodically and frequently, and when finding a good which has been purchased periodically and frequently among the plural goods of the commodity list, extracts said good as the good to be purchased.

6. The shopping supporting apparatus according to claim 1, wherein
the extracting unit refers to the history information of the electronic receipts to learn a day of the week of a discount day for each good at each store, and extracts from among the plural goods of the commodity list a good whose day of the week of the discount corresponds to the current day of the week as the good to be purchased.

7. A shopping supporting apparatus comprising:
an analyzing unit which analyzes purchase result of each good included in a classification of goods based on electronic receipts including the purchase history of goods and a remarked list indicating a remarked classification of goods; and
a shopping list creating unit which creates a shopping candidate list including a candidate good to be purchased, based on the result of the analysis performed by the analyzing unit.

8. The shopping supporting apparatus according to claim 7, wherein
the shopping list creating unit gives each candidate good included in the shopping candidate list store information of a store where said candidate good has been purchased actually.

9. The shopping supporting apparatus according to claim 7, further comprising:
a candidate extracting unit which extracts a good preferable for a user to purchase at present from among goods included in a shopping list and/or the shopping candidate list created by the shopping list creating unit, wherein the shopping list is a list of goods that should be purchased.

10. The shopping supporting apparatus according to claim 9, wherein
the candidate extracting unit extracts a good that is determined preferable for the user to purchase from among the goods included in the shopping list and/or the shopping candidate list created by the shopping list creating unit, based on present time-information.

11. The shopping supporting apparatus according to claim 9, wherein
the candidate extracting unit extracts a good that is determined preferable for the user to purchase from among the goods included in the shopping list and/or the shopping candidate list created by the shopping list creating unit, based on present position-information.

12. The shopping supporting apparatus according to claim 9, wherein
based on position information of a store whose new electronic receipt has been issued and received, the candidate extracting unit extracts a good that is determined preferable for the user to purchase at the store from among the goods included in the shopping list and/or the shopping candidate list created by the shopping list creating unit.

13. The shopping supporting apparatus according to claim 7, wherein
the purchase history of goods includes information of a purchase unit price of each good, and the apparatus further comprising:
an advice unit which gives notice of the information of a purchase unit price of the good included in the shopping candidate list based on the purchase history of goods and the remarked list.

14. The shopping supporting apparatus according to claim 13, wherein
the advice unit gives notice of plural purchase unit prices respectively at plural stores with respect to the good included in the shopping candidate list, allowing the user to compare the purchase unit prices of the good respectively at the plural stores.

15. A shopping supporting method in a shopping supporting apparatus having a receipt memorizing unit and a list memorizing unit, the method comprising:
a step of receiving an electronic receipt when a user of the apparatus has purchased goods at a store, which receipt clearly indicates a payment amount of the purchased goods and store information of the store at which the customer has purchased the goods;
a step of memorizing received electronic receipts as history information of the electronic receipts in the receipt memorizing unit;
a step of memorizing a list of plural goods to be remarked by the user in the list memorizing unit, wherein the list of plural goods is a commodity list created by the user at his/her arbitrary option;
a step of referring to the history information of the electronic receipts to extract a candidate good to be purchased at present or at a present position from among the plural goods included in the commodity list; and
a step of displaying the extracted candidate good.
